(19) United States
(12) Patent Application Publication
(10) Pub. No.: US 2004/0073509 A1
(43) Pub. Date: Apr. 15, 2004

(54) Network communication electronic commerce system

(76) Inventor: Sid Haddad, Bradenton, FL (US)

Correspondence Address: ARTHUR W. FISHER, III, Suite 316, 5553 West Waters Avenue, Tampa, FL, 33634, US

(21) Appl. No.: 09/858,215

(22) Filed: May 15, 2001

Related U.S. Application Data
(60) Provisional application No. 60/204,259, filed on May 15, 2000.

(51) Int. Cl. G06F 17/60

(52) U.S. Cl. 705/39; 705/26

(57) ABSTRACT

A network communication electronic commerce system for the secure online purchase of goods and services from a plurality of merchant vendors by a plurality of buyer members comprising a buyer member processor for each buyer member to selectively purchase goods and services upon a request to any of the merchant vendors through a debit account associated with a discrete e-mail address a merchant vendor processor for each merchant vendor to selectively provide such goods and services upon receipt of a purchase request and validation of the debit account balance of any buyer members and a purchase authorization processor to maintain and validate the debit account of buyer members and to authorize payment to merchant vendors for goods and services purchased through the network communication electronic commerce system.

### CROSS REFERENCE

this is a regular patent application claiming priority and converted from the provisional patent application filed May 15, 2000 assigned application serial No. 60/204,259.

### BACKGROUND OF THE INVENTION

1. Field of the Invention

A method and system for purchasing goods and services over a communication network such as the Internet using a debit account.

2. Description of the Prior Art

The World Wide Web can function as a means of electronic commerce through which vendors can advertise and sell various goods and services. Purchaser specific order data may contains information which merchants and purchasers alike may wish to secure against interception by at an intermediate system. To this end, numerous encryption techniques have been developed for use when transmitting such data. Unfortunately, the possibility still exists that such data or information may be intercepted and decrypted.

U.S. Pat. No. 5,715,314 discloses a network-based sales system including at least one buyer computer for operation by a user desiring to buy a product, at least one merchant computer and at least one payment computer interconnected by a computer network. The buyer computer is programmed to receive a user request for purchasing a product and to cause a payment message to be sent to the payment computer. The payment computer is programmed to receive the payment message, to cause an access message to be created that comprises the product identifier and an access message authenticator based on a cryptographic key, and to cause the access message to be sent to the merchant computer. The merchant computer is programmed to receive the access message, to verify the access message authenticator to ensure that the access message authenticator was created using the cryptographic key and to cause the product to be sent to the user desiring to buy the product.

U.S. Pat. No. 5,895,454 describes a method of effecting commerce in a networked computer environment. A database of vendor product data and an associated database interface is established on a first computer. The interface allows remote access by one or more user(s). A local user interacts with the database by querying the database to specify a local users product/service specification. The database provides the local user with a selection of remote vendor network sites, where the selection is determined on the basis of the user querying the database. After the local user interactively connects with one or more of the remote vendor networks site, the user selects product/services from the information provided on the remote vendor network site. The selection of a particular product/service triggers a transaction notification which records the users selection and associated financial transaction data which is transmitted to the database and associated database interface. During or at the conclusion of a local users shopping session, the user confirms the selection(s) whereby the database and associated database interface transmits purchase/ordering data to the remote vendor sites corresponding to the users selection.

U.S. Pat. No. 5,960,411 relates to a method and system for placing an order to purchase an item via the Internet. The order is placed by a purchaser at a client system and received by a server system. The server system receives purchaser information including identification of the purchaser, payment information, and shipment information from the client system. The server system then assigns a client identifier to the client system and associates the assigned client identifier with the received purchaser information. The server system sends to the client system the assigned client identifier and an HTML document identifying the item and including an order button. The client system receives and stores the assigned client identifier and receives and displays the HTML document. In response to the selection of the order button, the client system sends to the server system a request to purchase the identified item. The server system receives the request and combines the purchaser information associated with the client identifier of the client system to generate an order to purchase the item in accordance with the billing and shipment information whereby the purchaser effects the ordering of the product by selection of the order button.

Despite these examples of the prior art, there remains a need for an effective secure link for sensitive information involved in electronic commerce.

### SUMMARY OF THE INVENTION

The present invention relates to a network communication electronic commerce system for the secure online purchase of goods and services from a plurality of subscriber merchant vendors by a plurality of buyer members as described more fully hereinafter.

The network communication electronic commerce system comprises a buyer member processor for each buyer member to selectively purchase goods and services upon a request to one of the merchant vendors through a debit account associated with a discrete e-mail address assigned to each buyer member, a merchant vendor processor to selectively provide such goods and services upon receipt of a purchase request and validation of the debit account balance of the buyer member and a purchase authorization processor to maintain and validate the debit account of the buyer member and to authorize payment to the merchant vendor for goods and services purchased through the network communication electronic commerce system.

To implement the network communication electronic commerce system, a plurality of merchant vendors are organized into a network to offer goods and services over a communication system such as the Internet. Each such merchant vendor has a corresponding merchant vendor processor to sell goods and services to any of the buyer members when authorized by a central clearing organization or entity. The merchant vendors may provide online advertising of the goods and services offered through the network communication electronic commerce system.

To participate in the purchasing program, a buyer member establishes a debit account by depositing a minimum amount with the central clearing organization or entity which operates the purchase authorization processor. The deposit may be made online through the buyer member processor or directly to the central clearing organization or entity. The central clearing organization or entity creates a buyer member account, assigns a unique or discrete e-mail address for each buyer member account with the deposit. All subsequent online communications regarding any particular buyer member is associated only with the unique discrete e-mail address assign. Thus no credit card information or similarly sensitive data is available online, thereby eliminating intrusion or interception thereof to preclude theft or fraud.

A buyer member selects a desired product or service from a particular merchant vendor on the buyer member processor which transmits a purchase request to the merchant vendor processor. The merchant vendor processor inquires of the buyer member account balance data base or memory to determine if the buyer member has sufficient funds on account with the central clearing organization or entity to pay for the desired goods or services. If so, the buyer member account balance data base or memory of the purchase authorization processor generates and transmits a purchase authorization to the inquiring merchant vendor processor, notifies the buyer member processor of the purchase authorization and debits the buyer member account in the off line buyer member data base or memory either transmits payment directly to the merchant vendor processor of the participating member vendor or through a depository. The off line buyer member data base or memory includes means to determine the specific amount to be paid each merchant vendor for each product or service purchased by buyer members after deducting a clearing charge for the corresponding purchase.

If the account balance is insufficient to pay for a particular purchase request, both the merchant vendor and buyer member are notified by the central clearing organization or entity as the buyer member account balance data base or memory section of the purchase authorization processor generates and transmits a declination message to the merchant vendor processor and the buyer member processor.

The off line buyer member data base or memory includes memory to maintain both account and purchase histories of each buyer member off line to further protect purchasing habits and account funds of the buyer member.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a block diagram of the network communication electronic commerce system of the present invention.

Similar reference characters refer to similar parts throughout the several views of the drawings.

### DETAILED DESCRIPTION OF THE INVENTION

The present invention relates to a network communication electronic commerce system for the secure online purchase of goods and services from a plurality of subscriber merchant vendors by a plurality of buyer members as described more fully hereinafter.

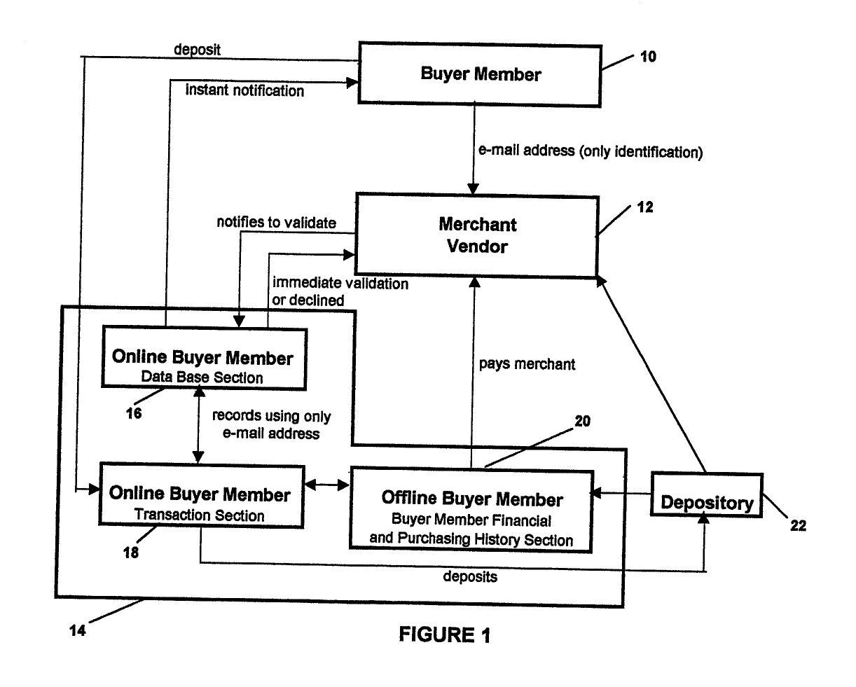

As shown in FIG. 1, the network communication electronic commerce system comprises at least one buyer member processor 10 to selectively purchase goods and services upon a request to a merchant vendor through a debit account associated with a discrete e-mail address, at least one merchant vendor processor 12 to selectively provide such goods and services upon receipt of a purchase request and validation of the debit account balance of the buyer member and a purchase authorization processor 14 to maintain and validate the debit account of the buyer member and to authorize payment to the merchant vendor for goods and services purchased through the network communication electronic commerce system.

The buyer member processor 10 may comprise a computer or other suitable means to selectively order or request goods and services from the merchant vendor through the merchant vendor processor 12 and to communicate with the purchase authorization processor 14 to maintain and access the buyer member account.

The merchant vendor processor 12 may comprise a computer or other suitable means to receive purchase requests from the buyer member processor 10 and to generate and transmit validation/authentication inquiries upon receipt of purchase requests to the purchase authorization processor 14 and to receive discrete buyer member authorization message in response thereto and to fill purchase requests upon receipt of the corresponding discrete buyer member authorization message and receive payment therefore.

The purchase authorization processor 14 may comprise a computer or other suitable means including an online buyer member account balance data base or memory section 16 to maintain current account balances for each buyer member and to selectively generate discrete buyer member authorization messages fed to the merchant vendor processor 12 when the account balance of a requesting buyer member is sufficient to cover the goods or services requested and to notify the buyer member processor 10 of the purchase authorization; an online buyer member transaction section 18 to receive credit/deposit transactions from individual buyer member processors 10 and credit the corresponding current account balance in the buyer member account balance data base or memory section 16, to receive purchase transaction data including goods and services purchased together with corresponding prices and merchant vendor information from the buyer member account balance data base or memory section 16 and to transfer the credit/deposit transaction and purchasing transaction data to an off line buyer member data base or memory 20 to maintain individual buyer member credit/deposit and purchase histories, and to effect merchant vendor payments to merchant vendors through the corresponding merchant vendor processor 12 upon receipt of a discrete buyer member authorization from the buyer member account balance data base or memory section 16 or online buyer member transaction section 18.

To implement the network communication electronic commerce system, a plurality of merchant vendors are organized into a network to offer goods and services over a communication system such as the Internet. Each such merchant vendor has a corresponding merchant vendor processor 12 to sell goods and services to any of the buyer members when authorized by a central clearing organization or entity. Although not shown, the merchant vendors may provide online advertising of the goods and services offered through the network communication electronic commerce system.

To participate in the purchasing program, a buyer member establishes a debit account by depositing a minimum amount with the central clearing organization or entity which operates the purchase authorization processor 14. The deposit may be made online through the buyer member processor 10 or directly to the central clearing organization or entity. The central clearing organization or entity creates a buyer member account, assigns a unique or discrete e-mail address for each buyer member account with the deposit. All subsequent online communications regarding any particular buyer member is associated only with the unique discrete e-mail address assign. Thus no credit card information or similarly sensitive data is available online, thereby eliminating intrusion or interception thereof to preclude theft or fraud.

A buyer member selects a desired product or service from a particular merchant vendor on the buyer member processor 10 which transmits a purchase request to the merchant vendor processor 12. The merchant vendor processor 12 inquires of the buyer member account balance data base or memory 16 the purchase authorization processor 14 to determine if the buyer member has sufficient funds on account with the central clearing organization or entity to pay for the desired goods or services. If so, the buyer member account balance data base or memory 16 of the purchase authorization processor 14 generates and transmits a purchase authorization to the inquiring merchant vendor processor 12, notifies the buyer member processor 10 of the purchase authorization and debits the buyer member account in the off line buyer member data base or memory 20 of the purchase authorization processor 14 either transmits payment directly to the merchant vendor processor 12 of the participating member vendor or through a depository 22. The off line buyer member data base or memory 20 includes means to determine the specific amount to be paid each merchant vendor for each product or service purchased by buyer members after deducting a clearing charge for the corresponding purchase.

If the account balance is insufficient to pay for a particular purchase request, both the merchant vendor and buyer member are notified by the central clearing organization or entity as the buyer member account balance data base or memory section 16 of the purchase authorization processor 14 generates and transmits a declination message to the merchant vendor processor 12 and the buyer member processor 10.

The off line buyer member data base or memory 20 of the purchase authorization processor 14 includes memory to maintain both account and purchase histories of each buyer member off line to further protect purchasing habits and account funds of the buyer member.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

What is claimed is:

1. A network communication electronic commerce system for the secure online purchase of goods and services from a plurality of merchant vendors by a plurality of buyer members comprising a buyer member processor for each buyer member to selectively purchase goods and services upon a request to any of the merchant vendors through a debit account associated with a discrete e-mail address, a merchant vendor processor for each merchant vendor to selectively provide such goods and services upon receipt of a purchase request and validation of the debit account balance of any requesting buyer members and a purchase authorization processor to maintain and validate the debit account of requesting buyer members and to authorize payment to merchant vendors for goods and services purchased through said network communication electronic commerce system.

2. The network communication electronic commerce system of claim 1 wherein said buyer member processor comprises means to selectively order or request goods and services from a merchant vendor through said merchant vendor processor and to communicate with the purchase authorization processor to maintain and access the buyer member account.

3. The network communication electronic commerce system of claim 2 wherein said merchant vendor processor comprises a means to receive purchase requests from a buyer member processor and to generate and transmit validation/authentication inquiries upon receipt of purchase requests to said purchase authorization processor and to receive discrete buyer member authorization message in response thereto and to fill purchase requests upon receipt of the corresponding discrete buyer member authorization message and receive payment therefore.

4. The network communication electronic commerce system of claim 3 wherein said purchase authorization processor comprises means including an online buyer member account balance data section to maintain current account balances for each buyer member and to selectively generate discrete buyer member authorization messages fed to said merchant vendor processor when the account balance of a requesting buyer member is sufficient to cover the goods or services requested and to notify said buyer member processor of the purchase authorization; an online buyer member transaction section to receive credit/deposit transactions from individual buyer member processors and credit the corresponding current account balance n the buyer member account balance data section, to receive purchase transaction data including goods and services purchased together with corresponding prices and merchant vendor information from said buyer member account balance data section and to transfer the credit/deposit transaction and purchasing transaction data to an off line buyer member data section to maintain individual buyer member credit/deposit and purchase histories, and to effect merchant vendor payments to merchant vendors through said corresponding merchant vendor processor upon receipt of a discrete buyer member authorization from said buyer member account balance data section on online buyer member transaction section.

5. The network communication electronic commerce system of claim 1 wherein said merchant vendor processor comprises a means to receive purchase requests from a buyer member processor and to generate and transmit validation/authentication inquiries upon receipt of purchase requests to said purchase authorization processor and to receive discrete buyer member authorization message in response thereto and to fill purchase requests upon receipt of the corresponding discrete buyer member authorization message and receive payment therefore.

6. The network communication electronic commerce system of claim 5 wherein said purchase authorization processor comprises means including an online buyer member account balance data section to maintain current account balances for each buyer member and to selectively generate discrete buyer member authorization messages fed to said merchant vendor processor when the account balance of a requesting buyer member is sufficient to cover the goods or services requested and to notify said buyer member processor of the purchase authorization; an online buyer member transaction section to receive credit/deposit transactions from individual buyer member processors and credit the corresponding current account balance n the buyer member account balance data section, to receive purchase transaction data including goods and services purchased together with corresponding prices and merchant vendor information from said buyer member account balance data section and to transfer the credit/deposit transaction and purchasing transaction data to an off line buyer member data section to maintain individual buyer member credit/deposit and purchase histories, and to effect merchant vendor payments to merchant vendors through said corresponding merchant vendor processor upon receipt of a discrete buyer member authorization from said buyer member account balance data section on online buyer member transaction section.

7. The network communication electronic commerce system of claim 1 wherein said purchase authorization processor comprises means including an online buyer member account balance data section to maintain current account balances for each buyer member and to selectively generate discrete buyer member authorization messages fed to said merchant vendor processor when the account balance of a requesting buyer member is sufficient to cover the goods or services requested and to notify said buyer member processor of the purchase authorization; an online buyer member transaction section to receive credit/deposit transactions from individual buyer member processors and credit the corresponding current account balance n the buyer member account balance data section, to receive purchase transaction data including goods and services purchased together with corresponding prices and merchant vendor information from said buyer member account balance data section and to transfer the credit/deposit transaction and purchasing transaction data to an off line buyer member data section to maintain individual buyer member credit/deposit and purchase histories, and to effect merchant vendor payments to merchant vendors through said corresponding merchant vendor processor upon receipt of a discrete buyer member authorization from said buyer member account balance data section on online buyer member transaction section.

8. The network communication electronic commerce system of claim 7 wherein said buyer member processor comprises means to selectively order or request goods and services from a merchant vendor through said merchant vendor processor and to communicate with the purchase authorization processor to maintain and access the buyer member account.

9. The network communication electronic commerce system of claim 1 wherein said purchase authorization is implemented through a central function through a central clearing organization to authorize the merchant vendor having a corresponding merchant vendor processor to sell goods and services to requesting buyer members.

10. The network communication electronic commerce system of claim 9 wherein each buyer member establishes a debit account by depositing an amount with the central clearing organization.

11. The network communication electronic commerce system of claim 10 wherein the deposit is made online through the buyer member processor.

12. The network communication electronic commerce system of claim 1 further comprises means to create a buyer member account, assign a unique e-mail address for each buyer member account with the deposit and all subsequent online communications regarding any particular buyer member is associated only with unique e-mail address.

13. The network communication electronic commerce system of claim 10 wherein the deposit is made to the central clearing organization.

14. The network communication electronic commerce system of claim 13 wherein the central clearing organization creates a buyer member account, assigns a unique e-mail address for each buyer member account with the deposit and all subsequent online communications regarding any particular buyer member is associated only with unique e-mail address assign.

15. The network communication electronic commerce system of claim 9 wherein the central clearing organization creates a buyer member account, assigns a unique e-mail address for each buyer member account with the deposit and all subsequent online communications regarding any particular buyer member is associated only with unique e-mail address assign.

16. The network communication electronic commerce system of claim 3 wherein said purchase authorization processor comprises means including an online buyer member account balance data section to maintain current account balances for each buyer member and to selectively generate discrete buyer member authorization messages fed to said merchant vendor processor when the account balance of a requesting buyer member is sufficient to cover the goods or services requested and to notify said buyer member processor of the purchase authorization; an online buyer member transaction section to receive credit/deposit transactions from individual buyer member processors and credit the corresponding current account balance n the buyer member account balance data section, to receive purchase transaction data including goods and services purchased together with corresponding prices and merchant vendor information from said buyer member account balance data section and to transfer the credit/deposit transaction and purchasing transaction data to an off line buyer member data section to maintain individual buyer member credit/deposit and purchase histories, and to effect merchant vendor payments to merchant vendors through said corresponding merchant vendor processor upon receipt of a discrete buyer member authorization from said buyer member account balance data section on online buyer member transaction section and further comprises a central clearing organization operating said purchase authorization to authorize the merchant vendor having a corresponding merchant vendor processor to sell goods and services to any of the buyer members.

17. The network communication electronic commerce system of claim 16 wherein a buyer member selects a desired product or dervice from a merchant vendor on said buyer member processor which transmits a purchase request to the merchant vendor processor, merchant vendor processor inquires of said buyer member account balance data section of the purchase authorization processor to determine if the buyer member has sufficient funds on account with said central clearing organization to pay for the desired goods or services and to generate and transmit a purchase authorization to the inquiring merchant vendor processor when sufficient funds exist.

18. The network communication electronic commerce system of claim 17 wherein said purchase authorization processor includes an off-line buyer data base to receive the debit and notifies the buyer member processor of the purchase authorization and debits the buyer member account.

19. The network communication electronic commerce system of claim 18 wherein the off-line buyer member data base includes means to determine the specific amount to be paid each merchant vendor for each product or service purchased by buyer members after deducting a clearing charge for the corresponding purchase.

20. The network communication electronic commerce system of claim 19 wherein the off-line buyer member data base purchase authorization processor includes memory to maintain both account and purchase histories of each buyer member off line to further protect purchasing habits and account funds of the buyer member.

21. The network communication electronic commerce system of claim 18 wherein the off-line buyer member data base purchase authorization processor includes memory to maintain both account and purchase histories of each buyer member off line to further protect purchasing habits and account funds of the buyer member.

22. The network communication electronic commerce system of claim 17 wherein said purchase authorization processor transmits payment directly to said merchant vendor processor of the participating member vendor.

23. The network communication electronic commerce system of claim 17 wherein said purchase authorization processor transmits payment directly to said merchant vendor processor of the participating member vendor through a depository.

24. The network communication electronic commerce system of claim 17 wherein if the account balance is insufficient to pay for a particular purchase request, both the merchant vendor and buyer member are notified by the central clearing organization as the buyer member account balance data of the purchase authorization processor generates and transmits a declination message to said merchant vendor processor and said buyer member processor.
